(19) United States
(12) Patent Application Publication
(10) Pub. No.: US 2005/0068878 A1
(43) Pub. Date: Mar. 31, 2005

(54) Data recording apparatus

(75) Inventors: Toshimitsu Itoh, Atsugi-shi (JP); Satoshi Tsuji, Atsugi-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: MITSUMI ELECTRIC CO., LTD, Tokyo (JP)

(21) Appl. No.: 10/858,668

(22) Filed: Jun. 1, 2004

(30) Foreign Application Priority Data
Sep. 30, 2003 (JP) 340470/2003

(51) Int. Cl. G11B 7/28

(52) U.S. Cl. 369/84

(57) ABSTRACT

A data recording apparatus includes a memory card reader, and an optical disk recording/reproduction device. The optical disk recording/reproduction device includes a unit for transmitting data read by the memory card reading, and for inhibiting the opening of a tray during the recording of data. The apparatus further has a unit for confirming, after the completion of data recording, that a memory card has been removed, a unit for opening the tray when the removal of the memory card has been confirmed and a tray ejection operation has been performed, and a unit for closing the tray after the tray has been open for a predetermined period of time.

This application claims priority to prior Japanese patent application JP 2003-340470, the disclosure of which is incorporated herein by reference.

### BACKGROUND OF THE INVENTION

The present invention relates to a data recording apparatus that includes an optical disk recording/reproduction device and a memory card reader, and in particular to the tray ejector of the optical disk recording/reproduction device of a data recording apparatus.

Conventionally, optical disks, such as CD-R, CD-RW, DVD-R, DVD-RW, DVD-RAM, DVD+R and DVD+RW disks, are employed as optical recording media, and CD-R/RW, DVD-R/RW, DVD-RAM, and DVD+R/RW drives are employed as devices for recording data on optical disks. Some optical disk devices each include an ejector provided with a tray that can be inserted or ejected (e.g., see Japanese Patent Laid-Open Publication No. 2002-15502, hereinafter referred to as reference document 1).

A tray on which a disk is loaded is provided for a device for the reproduction or the recording of an optical disk, such as a compact disk or a DVD. Conventionally, the insertion and ejection of the tray must be controlled, and in this case, since a disk sensor is required, the structure of the recording/reproduction device is complicated.

In addition to the optical disk recording device, a memory card reader has been proposed for reading data recorded on memory cards, such as an SD, a Compact Flash (trademark), a Memory Stick, an xD picture card and a Smart Media.

Recently, proposal has been made about a print machine which is placed in a print shop or the like to simply and privately print photo data recorded on such a memory card. However, such a print machine is not effective to record or copy the data recorded on the memory card onto a different medium, such as a CD-R or the like. In other words, consideration has been conventionally made at all neither about copying the data recorded on the memory card to another memory medium nor about a problem caused to occur on copying the data recorded on the memory card. Accordingly, the print machine can not sufficiently responded to customers' requirements.

### SUMMARY OF THE INVENTION

Taking the above described shortcomings into account, it is an object of the present invention to provide a data recording apparatus that is reliable and usable for copying data from a memory card to an optical disk.

According to one aspect of the invention, a data recording apparatus comprises:
a memory card reader; and
an optical disk recording/reproduction device,
wherein the optical disk recording/reproduction device includes
a unit for transmitting, to the optical disk recording/reproduction device, data read by the memory card reader, and for inhibiting the opening of a tray during the recording of data.

Preferably, the data recording apparatus of the invention further comprises:
a unit for confirming, after the completion of data recording, that a memory card has been removed; and
a unit for opening the tray when the removal of the memory card has been confirmed and a tray ejection operation has been performed.

More preferably, the data recording apparatus of this invention further comprises:
a unit for closing the tray after the tray has been open for a predetermined period of time.

According to another aspect of the invention, a data recording method, for a data recording apparatus for reading data from an inserted memory card and recording the data on an optical disk, comprises the steps of:
recording data read from a memory card on an optical disk; and
inhibiting during data recording the opening of a tray whereon the optical disk is placed.

Preferably, the data recording method of the invention further comprises the steps of:
confirming, after data has been recorded, that the memory card has been removed from the data recording apparatus; and
opening the tray after the removal of the memory card has been confirmed and a tray ejection operation has been performed.

Further, preferably, the data recording method of the invention additionally comprises the step of:
closing the tray when the tray has been open for a predetermined period of time.

That is, during the usage, the data recording apparatus of the invention detects the tray ejection operation, and automatically closes the tray when the tray has not been closed within a predetermined period of time.

### BRIEF DESCRIPTION OF THE DRAWING

FIG. 1 is a perspective view of a conventional optical disk insertion/removal device;

FIG. 2 is a diagram showing the structure and a block configuration of the optical disk insertion/removal device in FIG. 1;

FIG. 3 is a front view of the external appearance of a data recording apparatus that includes a memory card reader according to one embodiment of the present invention;

FIG. 4 is a plan view of the data recording apparatus in FIG. 3;

FIG. 5 is a rear view of the data recording apparatus in FIG. 3;

FIG. 6 is a bottom view of the data recording apparatus in FIG. 3;

FIG. 7 is a right side view of the data recording apparatus;

FIG. 8 is a left side view of the data recording apparatus;

FIG. 9 is a plan view of the state wherein a tray for an optical disk tray in FIG. 4 has been moved forward;

FIG. 10 is a block diagram showing the data recording apparatus shown in FIGS. 3 to 9; and

FIG. 11 is a flowchart for explaining the operation of the data recording apparatus for copying data from a memory card to a CD-R.

### DETAILED DESCRIPTION OF THE PREFERRED EMBODIMENT

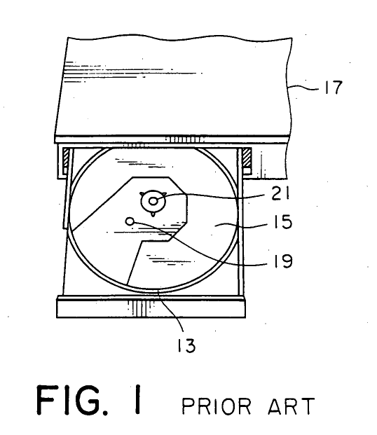

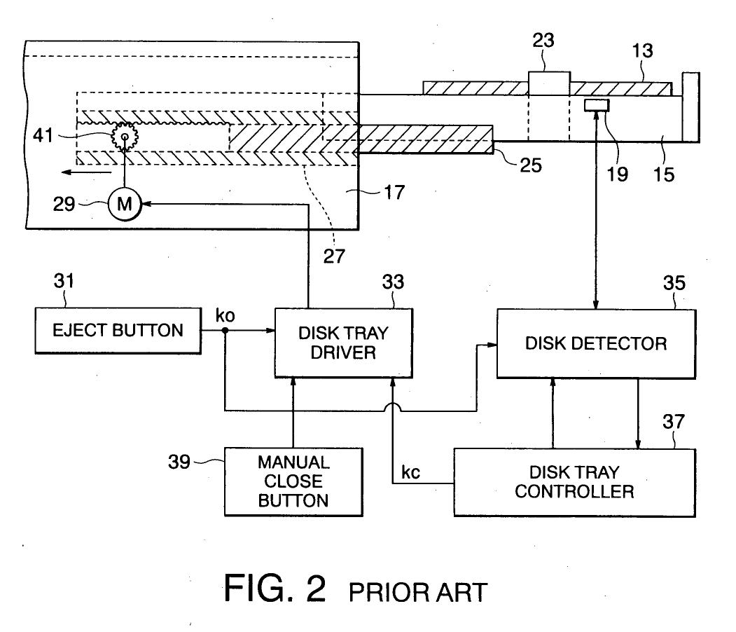

Before explaining the preferred embodiment of the present invention, and a conventional optical disk insertion/removal device will be described with reference to FIGS. 1 and 2 so as to facilitate the present invention.

Referring to FIG. 1, in the conventional optical disk insertion/removal device, an optical disk 13 is mounted on a disk tray 15 and is loaded into an optical disk drive 17, or is unloaded therefrom and removed. A disk sensor 19 is provided for the disk tray 15 in order to detect the presence/absence of an optical disk 13 on the disk tray 15. The disk sensor 19 includes, for example, a light-emitting element, such as a laser diode or an LED, and a light-receiving element, such as a photodiode or a phototransistor. The disk sensor 19 detects the presence/absence of an optical disk 13 by examining whether there is reflected light from the optical disk 13. The disk sensor 19 is positioned so it is inside the minimum radius of the optical disk 13, and a drive shaft 21 for driving the optical disk 13 is provided at the center of the disk tray 15.

Referring to FIG. 2, according to the conventional optical disk insertion/removal device shown in the reference document 1, an optical disk 13 is supported on the disk tray 15 by a disk holder 23. As a rack, a pinion or a pulley, provided along slide rails 25 and 27 and is driven by a motor 29. Thus, the disk tray 15 is moved either into or out of the optical disk drive 17.

An eject button 31 outputs an eject instruction ko to a disk tray driver 33 to eject the disk tray 15. The photodiode in the disk sensor 19 determines whether light emitted by the LED has been reflected by the surface of an optical disk 13, so that the presence/absence of an optical disk 13 can be ascertained. And a disk detector 35 transmits to a disk tray controller 37 a disk detection signal that is received from the disk sensor 19 and that indicates an optical disk 13 is present absent at a predetermined time.

Upon receiving the disk detection signal, the disk tray controller 37 stores the contents of the signal in an internal memory. And then, based on the detection process indicated by the disk detection signal, the disk tray controller 37 ascertains the state of the optical disk 13 relative to the disk tray 15, and transmits a close instruction kc of closing the disk tray 15 to the disk tray driver 33. Thereafter, the disk tray controller 37 employs an internal timer to notify the disk detector 35, at a predetermined time, of a disk detection time.

Based on the ejection instruction ko or the close instruction kc, the disk tray driver 33 drives the motor 29 to move the disk tray 15 either into or out of the optical disk device 17.

A manual close button 39 transmits to the disk tray driver 33 a close instruction kc for manually closing the disk tray 15, regardless of whether an optical disk 13 has been placed on the disk tray 15.

The operation of the thus arranged optical insertion/removal device will now be described. When the eject button 31 is depressed, the eject instruction ko is output to the disk tray driver 33. Then, in accordance with a drive signal output by the disk tray driver 33, the motor 29 is rotated, driving a drive gear 41, and the disk tray 15 is moved outward and opened. When the eject instruction ko is transmitted to the disk detector 35, the disk sensor 19 is turned on, and upon receiving a sensor signal from the disk sensor 19, the disk detector 35 examines whether or not the disk tray 15, which has been ejected, detects the presence/absence of an optical disk 13 thereon, and transmits a disk detection signal to the disk tray controller 37.

The disk tray controller 37 receives the disk detection signal from the disk detector 35, and at the same time, designates a tray open period during which the disk tray 15 is maintained open. Based on a disk detection signal received during this period and the detection process stored in the internal memory, the disk tray controller 37 determines whether an optical disk 13 has been loaded or unloaded, and automatically transmits a close instruction kc to the disk tray driver 33 to close the disk tray 15. When a predetermined manipulation is not confirmed, the disk tray controller 37 also transmits the close instruction kc automatically after the tray open period has elapsed.

When the disk tray driver 33 receives the close instruction kc from the disk tray controller 37, the motor 29 is driven to automatically store the disk tray 15 in the optical disk drive 17.

In this conventional optical disk insertion/removal mechanism, when the eject button 31 is depressed, the disk detector 35 activates the disk sensor (hereinafter referred to as an optical sensor) 19. Thereafter, the disk tray controller 37 receives a disk detection signal from the disk detector 35, and employs this disk detection signal to determine whether an optical disk 13 is present at the time of the ejection. After this determination has been made, the disk tray controller 37 opens the disk tray 15. When an optical disk 13 is not present on the disk tray 15, the disk tray controller 37 opens the disk tray 15, and subsequently determines whether an optical disk 13 is present. When the disk tray controller 37 determines that a new optical disk 13 has been mounted, the disk tray 15 is automatically closed. If an optical disk 13 has not been mounted, the disk tray controller 37 repeats the disk presence/absence determination process until a predetermined tray open period t1 has elapsed.

When the tray open period t1 has elapsed without an optical disk 13 being detected, the disk tray 15 is automatically closed. The disk tray 15 is also automatically closed if the mounting of an optical disk 13 is detected before the tray open period t1 has elapsed. This operation ensures that the disk tray 15 will not be left open.

When it is determined on detecting the ejection time that an optical disk 13 is present, the disk tray 15 is opened and determination is made about presence/absence of the optical disk 13. When the optical disk 13 is still present, the process for determining the presence/absence of an optical disk 13 is repeated until a predetermined tray open period t2 has elapsed. When the optical disk 13 is not removed during the tray open period t2, the disk tray 15 is automatically closed after the tray open period t2 has elapsed.

When the absence of an optical disk 13 is detected before the tray open period t2 has elapsed, the process for determining the presence/absence of an optical disk 13 is performed. When the absence of an optical disk 13 is again determined, the process for determining whether or not an optical disk 13 is present is repeated until a predetermined a disk absence period t3 has elapsed. If the mounting of an optical disk 13 is detected during the disk absence period t3, the disk tray 15 is automatically closed. The disk tray 15 is also automatically closed if the disk absence period t3 elapses before the mounting of an optical disk 13 is detected.

As is described above, when a new optical disk 13 is mounted within a predetermined period, or when no optical disk 13 is mounted within this period, the disk tray 15 is automatically closed. Therefore, the disk tray 15 is not left open, and the optical disk ejection operation is simplified. The tray open periods t1 and t2 and the disk absence period t3 are arbitrarily designated.

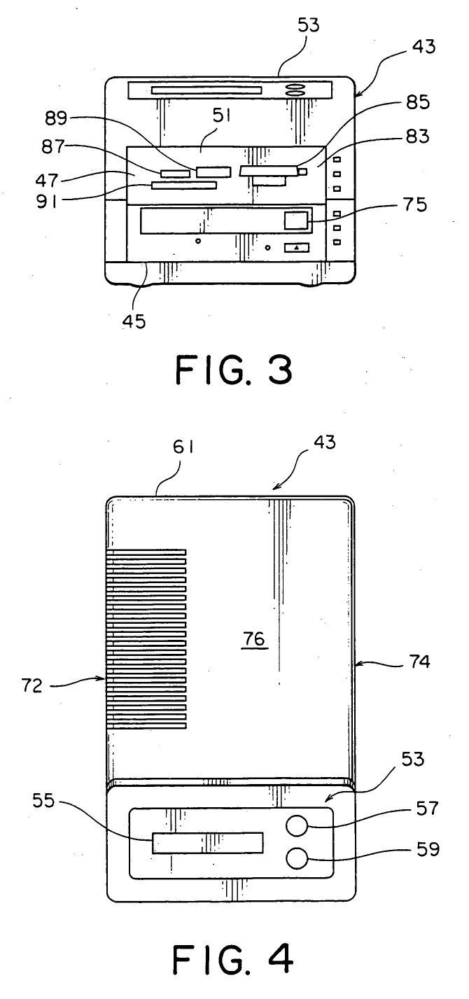

A data recording apparatus according to the preferred embodiment of the invention will now be described with reference to FIGS. 3 to 11.

As is shown in FIG. 3, a data recording apparatus 43 according to the embodiment has five inch bays 45 and 47 both of which have the same size as a bay for a personal computer (PC), are provided in the front face of a case or casing. An optical disk recording/reproduction device (a CD-R/RW in this embodiment), which can record data to and reproduce data from an optical disk, is mounted in the five-inch bay 45. The optical disk recording/reproduction device can also be a DVD-R/RW, a DVD+R/RW or a DVD-RAM drive.

A memory card reader 51 is mounted in the five-inch bay 47.

In this embodiment, the data recording apparatus 43 is only employed to write data recorded on a memory card to an optical disk, such as a CD-R.

An inclined operating panel 53 is provided on the top front face of the data recording apparatus 43. The operating panel 53 includes an LCD display portion 55, used to display the operation being performed, and a YES button 57 and a NO button 59, used to select the operation to be performed.

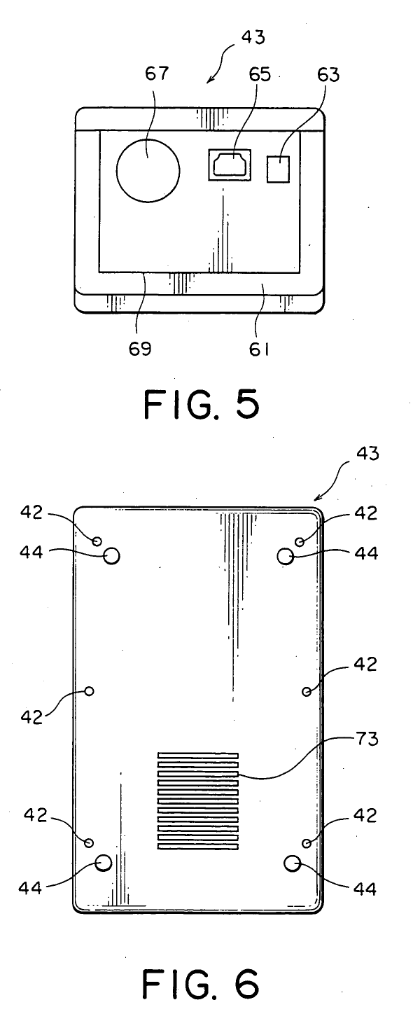

As is best shown in FIG. 5, a power supply section 69 is provided in a rear face 61, and includes a power switch 63, a power supply socket 65, and a ventilation hole 67 in which an exhaust fan is arranged to remove air from inside the apparatus.

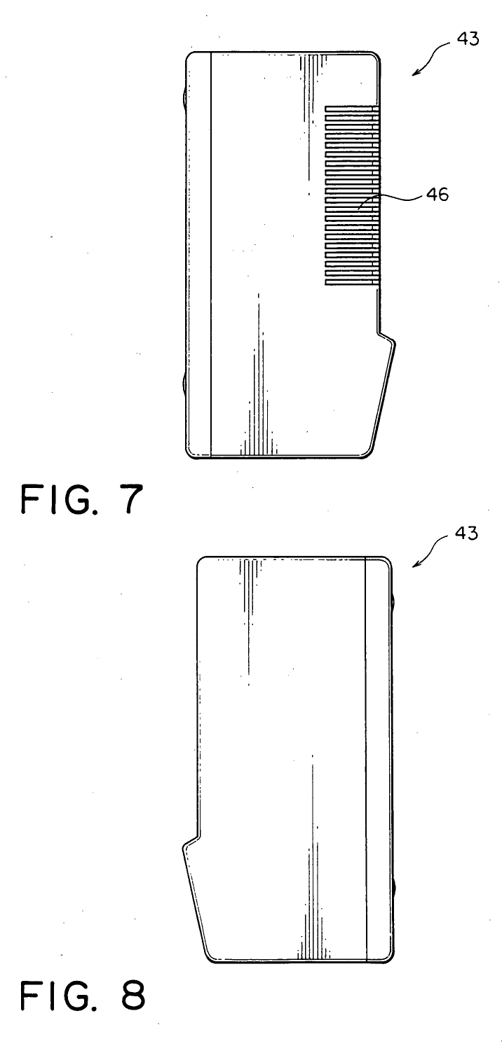

As is shown most clearly in FIGS. 4 and 7, a ventilation hole 46 having a grid shape is formed that extends from a right side face 72 to a top face 76.

Further, as is shown most clearly in FIGS. 6 and 7, a plurality of ventilation notches 73, elongated widthwise, are vertically arranged in the front end portion of a bottom face 71. Further, button-shaped legs 44 project outward from the bottom face 71 and screw holes 42 are formed near its edges.

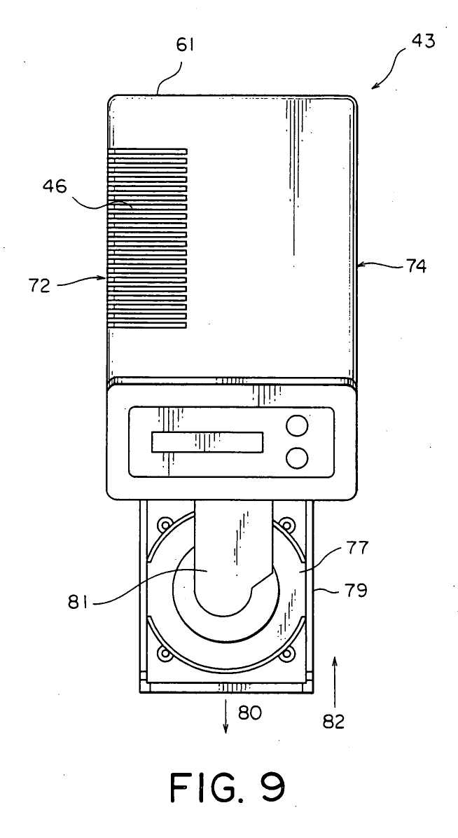

Furthermore, as is shown in FIG. 9, a CD-R/RW drive 75 is operable in response to an eject instruction to eject the tray 79 from a recessed disk storage portion 77 for stocking an optical disk, in the direction indicated by an arrow 80. A hole 81 is used to bring a reading and rotating mechanism in a CD-RW into contact with, or near, an optical disk that has been placed on the tray 79. It should be noted that thereafter the tray 79 is moved in the direction indicated by an arrow 82 and stocked inside the data recording apparatus 43.

The thus arranged data recording apparatus 43 is located mainly in front of a shop, and is used to copy, onto a CD-R disk, photo data that are obtained from a digital camera and that are recorded on a memory card.

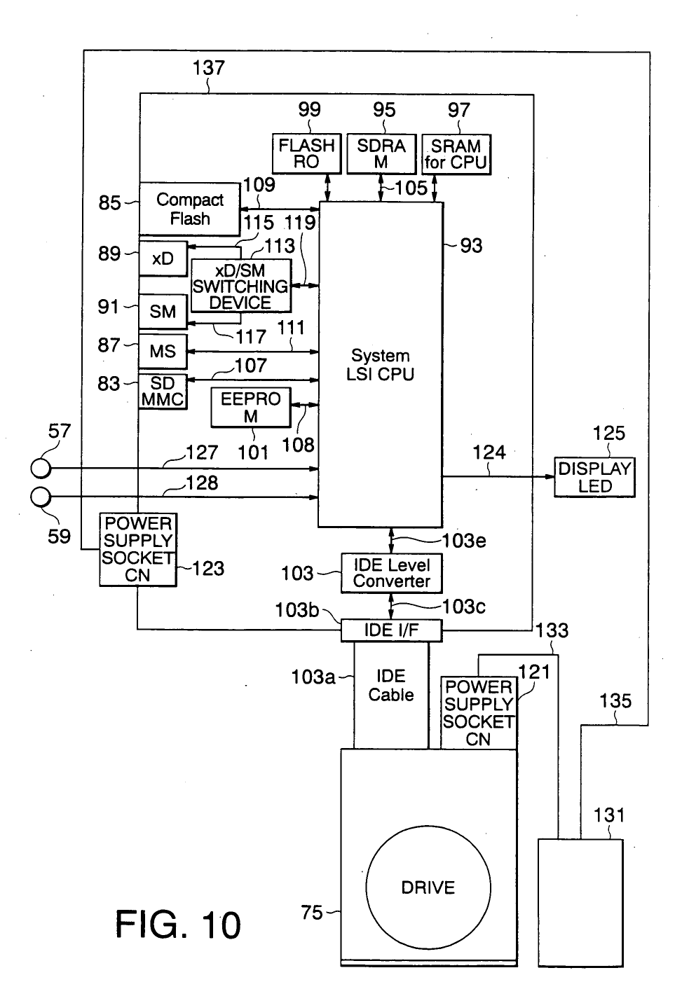

Referring to FIG. 10, the data recording apparatus 43 comprises: the CD-R/RW drive 75, a power source 131, and individual memory readers mounted on a main substrate 137 (i.e., an SD card reader 83, a Compact Flash (trademark) reader 85, a Memory Stick reader 87, an xD picture card reader 89, and a Smart Media reader 91). The YES switch or button 57 and the NO switch or button 59 are connected to a CPU 93 through signal lines 127 and 128.

The data recording apparatus 43 further comprises: the SYSTEM LSI (CPU) 93, a random access memory (SDRAM) 95, an SRAM (Static RAM) 97, a flash ROM 99 in which a program is stored that is used for the system operations of the data recording device 43, and an EEPROM (Electrically Erasable Programmable ROM) 101, which stores various setups for the data recording device 43. The CD-R/RW drive 75 is connected to the CPU 93 via a data bus 103, and the RAM 97 is connected to the CPU 93 via a data bus line 105. The memory card readers 83, 85 and 87 are connected to the CPU 93 via bus lines 107, 109 and 111, while the memory card readers 89 and 91 are connected to a picture card and smart media switching device 113 via bus lines 115 and 117. The switching device 113 is connected to the CPU 93 via a bus line 119. The CPU 93 includes interfaces for individual memory card connections, and performs all the processes, such as reading data from a memory card and writing data to a CD-R/RW. The RAM (SDRAM) 95 is used to store data read from a memory card, and data used for program execution. The CD-R/RW 75 is connected to the CPU 93 via a bus line 103e, an IDE level converter 103, a bus line 103c, an IDE interface (I/F) 103b, and an IDE cable 103a. Power supply sockets 121 and 123, and an LED 125, which exemplified as a display unit, are also provided.

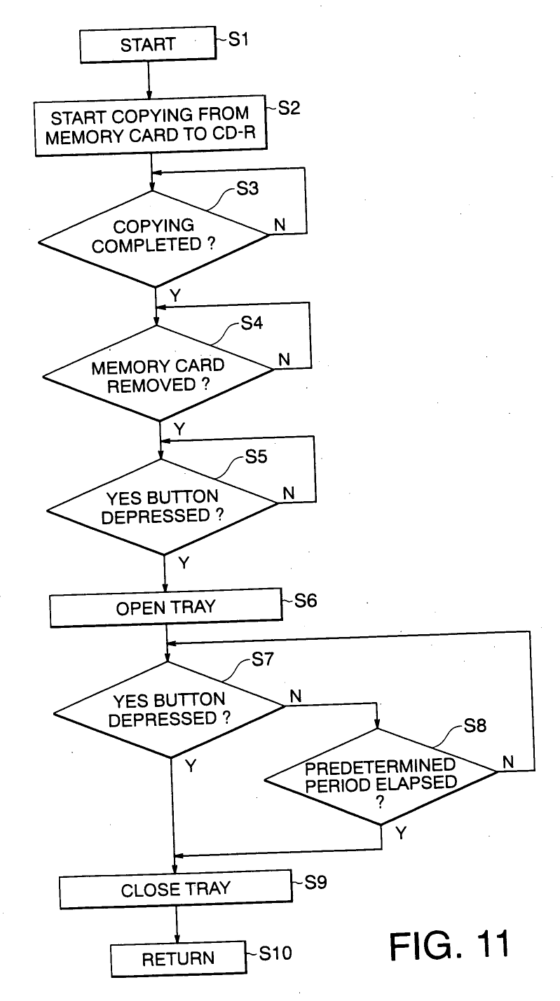

Referring to FIG. 11, first, a memory card is inserted into a memory card slot and a CD-R is loaded into the CD-R/RW drive 75. In this state, locking means inhibits the opening of the CD-R/RW drive 75. When at step S1 the processing is started, data is read from the memory card and is temporarily stored in the RAM 95 (card data reading means). Then, the data stored in the RAM 95 is transmitted through the CPU 93 to the CD-R/RW drive 75. The received data is then written to the CD-R by the CD-R/RW drive 75 (S2), and a message stating that data writing is in progress is displayed on the display panel. Following this, a check is performed to determine whether all the data that were read have been written, i.e., the copying of data has been completed (S3).

When the copying has not been completed, the message stating that data writing is in progress is continuously displayed, and writing end determination means again performs the process for determining whether data writing has been completed. This operation is repeated at constant time intervals. Then, when a writing end message is displayed, a check is performed to determine whether the memory card has been removed (S4). When the memory card has not been removed (NO), this process is also repeated at constant time intervals. When the memory card has been removed, a check is performed to determine whether the YES button 57 of the CD-R/RW drive 75 has been depressed in order to open the tray 79 (S5). When the YES button 57 has not been depressed, this process is repeated at constant time intervals. When the YES button 57 has been depressed and then the signal 127 representing it is input into the CPU 93, the CPU commands to open the tray 79 through the data line 103 (e, c, b, a) and then the tray 79 is opened as is shown in FIG. 9 (S6). As is described above, since manipulation of the eject button is inhibited until the memory card has been removed, forgetting to remove the memory card can be prevented.

Next, a check is performed to determine whether the YES button 57 has been depressed again (S7). When the YES button 57 has been depressed again, tray opening prevention means returns the tray 79 to the closed position (tray closing, S9) and the above described process is repeated (return, S10). When the YES button 57 has not been depressed at step S7, a check is performed to determine whether a predetermined period T1 has elapsed (S8). When the predetermined period T1 has not yet elapsed, program control returns to the process (S7) for determining whether the YES button 57 has been depressed. These processes are repeated until the predetermined period T1 has elapsed. Then, after the predetermined period T1 has elapsed, the tray 79 is closed (S9) and program control returns to the processing start (S10).

As is described above, according to the embodiment of the invention, when the depression of the YES switch or button 57 to close the open tray 79 is forgotten, the tray opening prevention means automatically closes the tray 79 after the predetermined period T1 has elapsed. Therefore, dust can be prevented from entering the recording apparatus 43, and the recording apparatus 43 can be protected from the occurrence of associated malfunctions.

After data has been written to a CD-R, the tray 79 is pulled forward, and the CD-R Is removed. When the tray 79 is left open for the predetermined period, it is automatically closed, so that the apparatus can be protected from being damaged by a person or an object hitting a tray that has been left open.

As is described above, since the data recording apparatus of the invention comprises a memory card reader and an optical disk recording/reproduction device, data such as image data recorded on a memory card can be copied to the optical disk and employed.

According to the present invention, the use of a simple structure to copy data from a memory card to an optical disk is enabled. Further, forgetting to remove a memory card can be prevented, and the apparatus can be protected from being damaged by a person or an object hitting a tray that has been left open.

Although the present invention has been shown and described in conjunction with the preferred embodiment thereof, it will readily be understood by those skilled in the art that the present invention is not limited to the foregoing description but may be changed and modified in various other manners without departing from the spirit and scope of the present invention as set forth in the appended claims.

1. A data recording apparatus comprising:
a memory card reader; and
an optical disk recording/reproduction device,
wherein the optical disk recording/reproduction device includes
a unit for transmitting, to the optical disk recording/reproduction device, data read by the memory card reader, and for inhibiting the opening of a tray during the recording of data.

2. A data recording apparatus according to claim 1, further comprising:
a unit for confirming, after the completion of data recording, that a memory card has been removed; and
a unit for opening the tray when the removal of the memory card has been confirmed and a tray ejection operation has been performed.

3. A data recording apparatus according to claim 1, further comprising:
a unit for closing the tray after the tray has been open for a predetermined period of time.

4. A data recording apparatus according to claim 1, wherein only one operation of reading data from the memory card and of writing the data to an optical disk is performed.

5. A data recording apparatus according to claim 1, wherein the memory card reader and the optical disk recording/reproduction device are integrally constituted.

6. A data recording method, for a data recording apparatus for reading data from an inserted memory card and recording the data on an optical disk, comprising the steps of:
recording data read from the memory card on to optical disk; and
inhibiting, during data recording, the opening of a tray whereon the optical disk is placed.

7. A data recording method according to claim 6, further comprising the steps of:
confirming, after data has been recorded, that the memory card has been removed from the data recording apparatus; and
opening the tray after the removal of the memory card has been confirmed and a tray ejection operation has been performed.

8. A data recording method according to claim 6, further comprising the step of:
closing the tray when the tray has been open for a predetermined period of time.

9. A data recording method according to claim 6, further comprising the step of:
performing only one operation of reading data from the memory card and writing the data to the optical disk.

10. A data recording method according to claim 6, whereby the data recording apparatus is employed to perform only one operation of reading data from the memory card and writing the data to the optical disk.

11. A data recording apparatus comprising:
a memory card reader for a memory card; and
an optical disk recording/reproduction device for an optical disk,
the optical disk recording/reproduction device comprising:
a unit for reading data out of the memory card reader; and
a unit for transmitting the data read out of the memory card to the optical disk recording/reproduction device to record the data onto the optical disk.

12. A data recording apparatus as claimed in claim 11, further comprising:
a unit for protecting the optical disk from being ejected until the data is being recording onto the optical device.
